(19) United States
(12) Patent Application Publication
(10) Pub. No.: US 2010/0050068 A1
(43) Pub. Date: Feb. 25, 2010

(54) INFORMATION DISPLAY DEVICE

(76) Inventor: Shinya Usami, Tokyo (JP)

Correspondence Address: Mr. Jackson Chen, 6535 N. STATE HWY 161, IRVING, TX, 75039, US

(21) Appl. No.: 12/529,388

(22) PCT Filed: Mar. 4, 2008
(86) PCT No.: PCT/JP2008/053870

§ 371 Date: Sep. 1, 2009

(30) Foreign Application Priority Data
Mar. 8, 2007 (JP) 2007 059219

(51) Int. Cl. G06F 17/00

(52) U.S. Cl. 715/206

(57) ABSTRACT

An information display device accesses URLs of a plurality of bookmarks in a group at a time by only selecting the group, instead of selecting each bookmark, and displays in accordance with information on a display window stored for each bookmark. An information display device 1 includes: a storage unit 5 that stores a bookmark; a group registration unit 6 that stores the bookmarks as a group along with a display position and size of a window displaying information on each website; and a selection unit 7 that selects the bookmarks that are registered as the group. An operator only selects the group using the selection unit 7, and the information display device 1 accesses URLs of the registered bookmarks at a time and displays on the display means 4, the acquired data in accordance with the size and position of the display window stored for each bookmark.

### TECHNICAL FIELD

The present invention relates to an information display device and more particularly to an information display device that displays information acquired from websites and so on by communication means.

### BACKGROUND ART

When data of a website is browsed using a personal computer or a mobile terminal, it is often necessary to browse information on a plurality of websites, such as a weather forecast, economic information and sport information.

However, when a plurality of websites are accessed in the related art, a selection of a bookmark needs to be repeated by the number of the websites. Furthermore, in the case where a lot of bookmarks have been registered, it is necessary to search for a corresponding bookmark therefrom.

Moreover, if data of a plurality of websites is displayed on a single screen, it is necessary to adjust the size of each window, each time of the data acquisition.

Moreover, it takes a certain period of time to acquire data if the data size to be acquired is big or communication rate is low, when information on websites is acquired. In addition, information on any websites cannot be fully browsed until the acquisition of all the information on the accessed websites is completed, and it is necessary to wait the completion during the data acquisition.

For example, Patent Documents 1 to 3 disclose the above related art, which displays data of a plurality of websites on a single screen. These Patent Documents are to display information like a thumbnail on a single window.

For example, Patent Document 4 discloses the related art that displays information on separated windows.
Patent Document 1: WO 01/063473
Patent Document 2: Japanese Laid-Open Patent Publication No. 2001-092748
Patent Document 3: Japanese Laid-Open Patent Publication No. 2002-196970
Patent Document 4: Japanese Laid-Open Patent Publication No. 2004-118272

### DISCLOSURE OF INVENTION

### Problem to be Solved by the Invention

However, the above related arts have the following problems.

The related arts disclosed in Patent Documents 1 to 3 are to display information like a thumbnail on a single window. However, since the thumbnail does not display the content in the same way as the normal window does, a separated window needs to be newly opened from this window in order to confirm the content.

Although the related art disclosed in Patent Document 4 is to open and display a plurality of separated windows, because Patent Document 4 does not disclose a configuration to display each window at a designated position, it has a problem of a bad visibility, for example, overlapping of windows, as shown in FIG. 10 of Patent Document 4.

The present invention has been made in consideration of the above problems, and an object of the present invention is to access URLs of a plurality of bookmarks in a group at a time by only selecting the group instead of selecting each bookmark, and to display in accordance with information on a display window stored for each bookmark in an information display device.

### Means for Solving the Problems

In order to achieve the object, the first aspect of the present invention is an information display device including: a storage unit that stores a URL of a website as a bookmark; a group registration unit that registers the plurality of bookmarks as a group; a selection unit that selects all bookmarks belonging to a certain group when an operator selects the group; a communication unit that accesses a website and acquires data from the website; and a display unit that displays the data acquired by the communication unit, wherein, when the selection unit selects a certain group, the communication unit accesses websites indicated by URLs of all bookmarks belonging to the group and acquires data, and the display unit displays all the acquired data in accordance with a display position and a display size of a display window registered in the group registration unit.

The second aspect of the present invention is the information display device in accordance with the first aspect, wherein the group registration unit registers the bookmark, along with the display position and the display size of the display window of when the display unit displays the data acquired from the website indicated by the URL of the bookmark.

The third aspect of the present invention is the information display device in accordance with the first or second aspect, wherein the group registration unit registers the bookmark along with a priority of a data acquisition order of when the data is acquired from the website indicated by the URL of the bookmark, and when the selection unit selects a certain group, the communication unit acquires data from websites indicated by URLs of all bookmarks belonging to the group in order, in accordance with the registered priority.

The fourth aspect of the present invention is the information display device in accordance with the third aspect, wherein the display unit displays the data in order, once the communication unit acquires the data from the website indicated by the URL of the bookmark.

The fifth aspect of the present invention is the information display device in accordance with any one of the first to fourth aspects, wherein when the group registration unit performs the group registration, the display unit displays a list of the bookmarks stored in the storage unit, and the group registration unit performs grouping by designating the bookmarks that the operator desires to register as the group.

The sixth aspect of the present invention is the information display device in accordance with any one of the first to fifth aspects, wherein the group registration unit registers bookmarks created by directly inputting URLs of websites as the group, instead of the bookmarks stored in the storage unit when the group registration is performed.

### Effect of the Invention

According to the present invention, it is possible to access URLs of a plurality of bookmarks in a group at a time by only selecting the group instead of selecting each bookmark, and to display in accordance with information on a display window stored for each bookmark in an information display device.

### BEST MODE FOR CARRYING OUT THE INVENTION

Hereinafter, an exemplary embodiment of the present invention will be described. First, a summary of the present embodiment will be described.

“Simplified access means to a plurality of websites” according to the present embodiment is to improve operability of access by grouping a plurality of bookmarks (a function to store as a “bookmark”) having URLs to be accessed, when websites in the Internet are accessed with a viewer for browsing (hereinafter, browser) installed in a personal computer or a mobile terminal device (hereinafter, mobile terminal).

There are numerous websites and it is typically required to register a URL as a bookmark if a user desires to access a website again. However, if the user desires to access a plurality of websites again, a selecting operation of a bookmark needs to be repeated by the number of the websites. For example, in the case the user gets up in the morning and accesses a website with a browser in a personal computer or a mobile terminal to check a weather forecast, economic information and sport information, it is required to select the corresponding bookmarks of a total of three times.

In the present embodiment, which will be described below, a plurality of bookmarks of websites that are desired to access are registered as a group, so that it is possible to access URLs of the plurality of bookmarks in the group at a time by only selecting the group instead of selecting each bookmark.

Furthermore, a display position and size of a window displaying information on each website are stored as group information, so that a state of each window of when group registration has been performed can be reproduced.

Furthermore, although data acquisition requires a certain period of time for acquiring information on a website, a priority of a data acquisition order is stored as the group information and data with a higher priority can be preferentially acquired, so that the data that has been already acquired can be browsed during acquisition of data with the next higher priority. Therefore, an actual waiting time of a user for acquiring data (the time while the user only waits the completion of the data acquisition and cannot browse data) can be reduced.

That is, in the “simplified access means to a plurality of websites” according to the present embodiment, a plurality of bookmarks of websites that are desired to access are grouped, so that the URLs of the plurality of bookmarks in the group can be accessed at a time when the group is selected. Furthermore, as group information, a display size and position of a window displaying information on each website are stored, so that a state of each window of when the group registration has been performed can be reproduced. Furthermore, a priority of a data acquisition order is stored as the group information and data with a higher priority is preferentially acquired, so that the data that has been already acquired can be browsed during acquisition of data with the next higher priority. Therefore, an actual waiting time of a user for acquiring data can be reduced.

This is the end of the explanation of the summary of the present embodiment. Hereinafter, a configuration according to the present embodiment of the present invention will be described with reference to the drawings. FIG. 1 shows the configuration of the present embodiment.

Referring to FIG. 1, an information display device 1 includes: communication means 3 for accessing to a website 2 in the Internet and acquiring data from the website 2; display means 4 including a browser that displays the acquired data; storage means 5 for storing a bookmark having title information and a URL of the accessed website; group registration means 6 for storing the bookmarks as a group along with a display position and size of a window displaying information on each website, a priority of a data acquisition order when the websites are accessed, and title information of the group; and selection means 7 for selecting the bookmark or the bookmarks registered as the group.

The present embodiment includes the above configuration operates as follows.
1. A Group Registration Operation of Bookmarks and Its Registration Content

A group registration operation of bookmarks and its registration content according to the present embodiment will be described with reference to FIGS. 2 and 3.

An operator activates a browser installed in a personal computer or a mobile terminal (S201), selects one of bookmarks that is desired to register as a group, accesses a website having the URL to acquire data, and displays the acquired data with the browser (S202). After the data acquisition is completed (S203), the operator selects a bookmark different from the bookmark whose data has been previously acquired, accesses a website to acquire data. At this time, the browser displays the data on a window different from a one displaying the data that has been previously acquired (S204). This operation is repeated to all the bookmarks that are desired to register as the group (S205, S206).

Next, a display position and size are adjusted for each window in the state where the plurality of windows are displaying the data. (S207).

After the display position and size are adjusted for each window, an operation for group registration is performed (S208), and the bookmark is registered as the group. In the group registration, a priority of a data acquisition order is designated in order to use the group including the bookmarks the next time, and this data is registered together (S209, S210).

The group registration of the bookmarks is completed by performing the above-described operation. Data registered as a group includes a title of a bookmark, a URL, a display position and a display size of a window, a priority of a data acquisition order at the time of an access, and a title of a group (FIG. 3).

2. An Access Manipulation and Operation to Websites Using Bookmarks Registered as a Group.

An access manipulation and operation to websites using bookmarks registered as a group according to the present embodiment will be described with reference to FIG. 4.

An operator activates a browser installed in a personal computer or a mobile terminal (S401), selects bookmarks having registered as a group (S402). While data acquisition from a website starts after the selection, then, an access is performed to a URL of a bookmark with the highest priority of a data acquisition order, and then the data is acquired from the website (S403). After the data acquisition is completed (S404), the browser displays the acquired data, based on a stored window position and size (S405).

Next, an access is performed to a URL of a bookmark with the next highest priority of the data acquisition order (S406). After the data acquisition is completed (S407), the browser displays the acquired data likewise as above, based on a stored window position and size (S408). This operation is repeated until the data acquisition for all the bookmarks registered as the group is completed (S409, S410).

This is the end of the explanation of the operation of the present embodiment. In addition, the present invention is not limited to the above described exemplary embodiment. For example, the following variations are also possible.

In the above “1. A group registration operation of bookmarks and its registration content”, although the website is accessed using the stored bookmark, and the grouping operation is successively performed, it is also possible to access websites by directly inputting URLs of websites and successively group such bookmarks.

In the group registration operation, it is also possible to display a list of the stored bookmarks instead of accessing the website and perform the grouping by designating the bookmarks that are desired to register as the group.

The effect of the present embodiment will be described below.

In the related art, if a user desires to access a plurality of websites at a time, a selecting operation of a bookmark needs to be repeated by the number of the websites. According to the present embodiment, such effect is achieved by only selecting a group so that operability can be improved.

Furthermore, according to the above exemplary embodiment, a position and size are designated for each separated window, whereby all windows can be displayed in a desired manner at once. Moreover, since a state of when group registration has been performed can be reproduced for each window, it is not necessary to adjust the display positions and sizes of the plurality of windows, while it is necessary to adjust each time when access is performed in the related art.

Furthermore, data with a higher priority is preferentially acquired, so that other data can be acquired during browsing the data that has been already acquired. Therefore, a waiting time for acquiring data can be reduced.

This application is based upon and claims the benefit of priority from Japanese patent application No. 2007-059219, filed on Mar. 8, 2007, the disclosure of which is incorporated herein in its entirety by reference.

### BRIEF DESCRIPTION OF THE DRAWINGS

FIG. 1 is a block diagram illustrating a configuration according to an exemplary embodiment of the present invention.

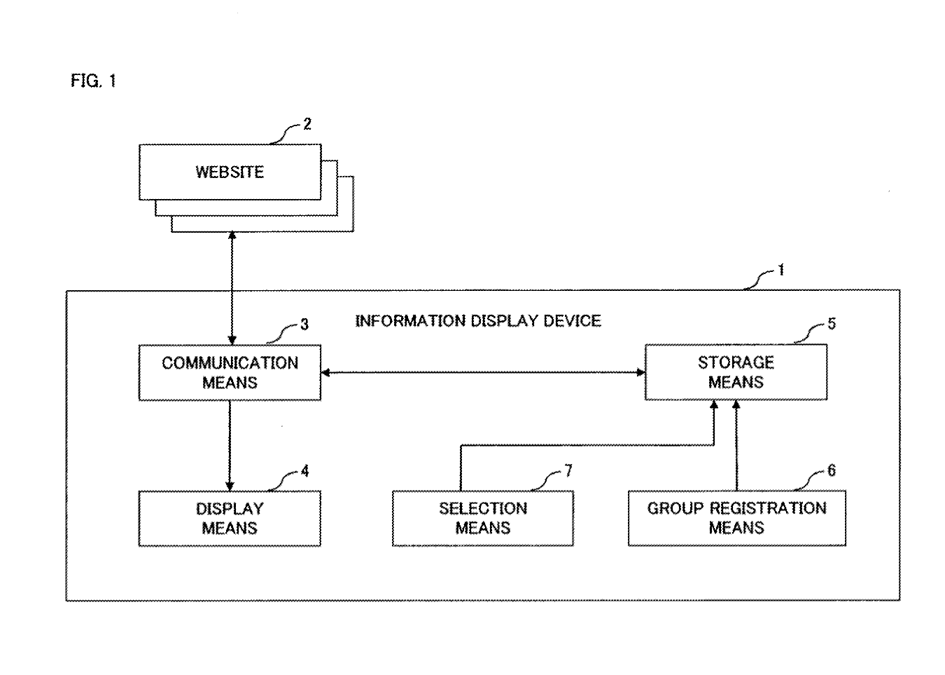

FIG. 2 is a flow chart illustrating an operation regarding a manipulation for group registration according to the exemplary embodiment of the present invention.

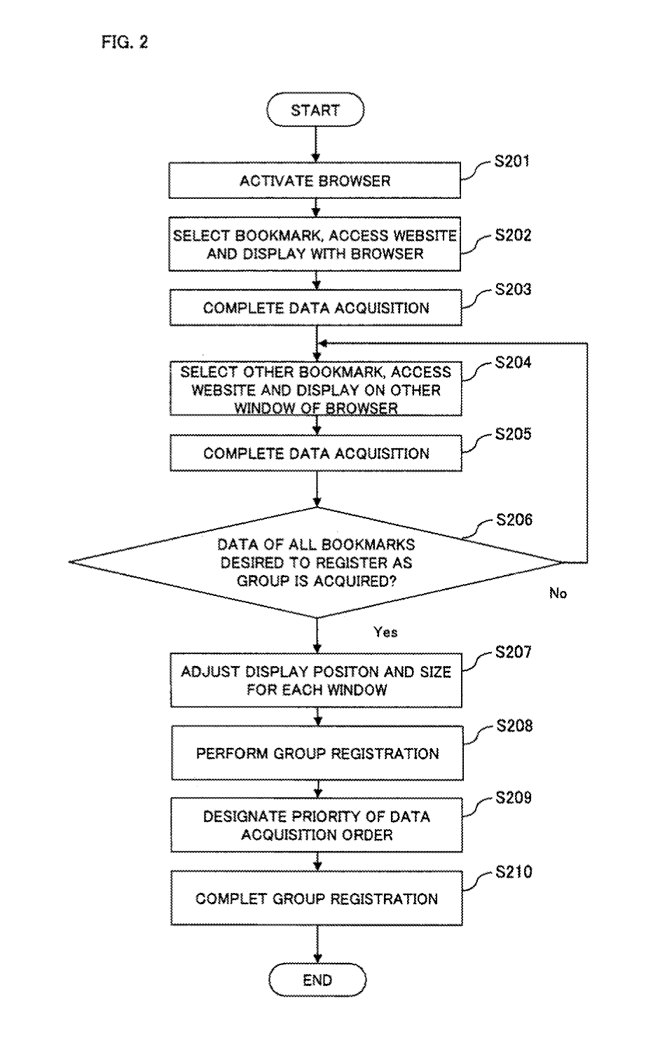

FIG. 3 is a diagram illustrating an example of a data table stored as a group according to the exemplary embodiment of the present invention.

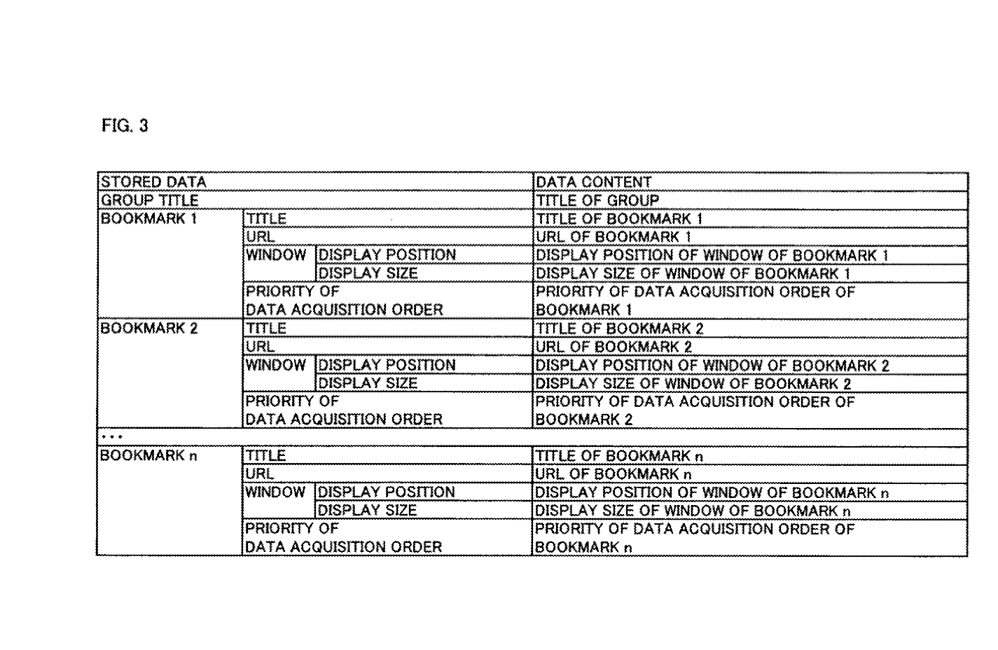

FIG. 4 is a flow chart illustrating an operation regarding an access manipulation according to the exemplary embodiment of the present invention.

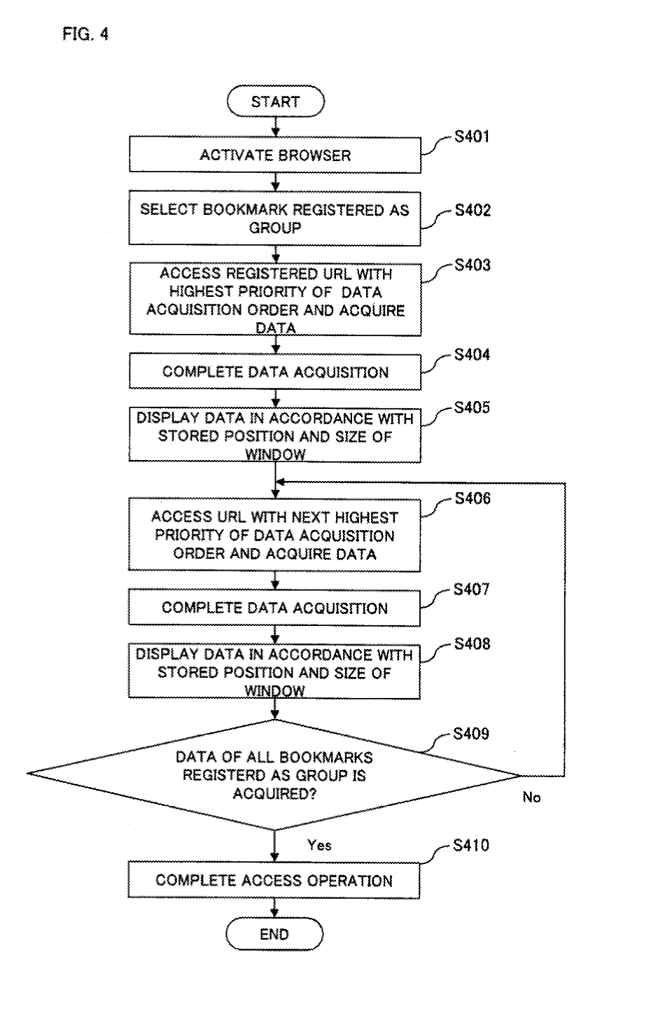

### DESCRIPTION OF REFERENCE NUMERALS

1. Information display device
2. Web site
3. Communication means
4. Display means
5. Storage means
6. Group registration means
7. Selection means

1. An information display device comprising:
a storage unit that stores a URL of a website as a bookmark;
a group registration unit that registers the plurality of bookmarks as a group;
a selection unit that selects all bookmarks belonging to a certain group when an operator selects the group;
a communication unit that accesses a website and acquires data from the website; and
a display unit that displays the data acquired by the communication unit,
wherein, when the selection unit selects a certain group, the communication unit accesses websites indicated by URLs of all bookmarks belonging to the group and acquires data, and
the display unit displays all the acquired data in accordance with a display position and a display size of a display window registered in the group registration unit.

2. The information display device in accordance with claim 1,
wherein the group registration unit registers the bookmark, along with the display size and the display position of the display window of when the display unit displays the data acquired from the website indicated by the URL of the bookmark.

3. The information display device in accordance with claim 1,
wherein the group registration unit registers the bookmark along with a priority of a data acquisition order of when the data is acquired from the website indicated by the URL of the bookmark, and
when the selection unit selects a certain group, the communication unit acquires data from websites indicated by URLs of all bookmarks lo belonging to the group in order, in accordance with the registered priority.

4. The information display device in accordance with claim 3,
wherein the display unit displays the data in order, once the communication unit acquires the data from the website indicated by the URL of the bookmark.

5. The information display device in accordance with, claim 1,
wherein, when the group registration unit performs the group registration, the display unit displays a list of the bookmarks stored in the storage unit, and
the group registration unit performs grouping by designating the bookmarks that the operator desires to register as the group.

6. The information display device in accordance with claim 1,
wherein the group registration unit registers bookmarks created by directly inputting URLs of websites as the group, instead of the bookmarks stored in the storage unit when the group registration is performed.

7. An information display device comprising:
storage means for storing a URL of a website as a bookmark;
group registration means for registering the plurality of bookmarks as a group;
selection means for selecting all bookmarks belonging to a certain group when an operator selects the group;
communication means for accessing a website and acquiring data from the website; and
display means for displaying the data acquired by the communication means,
wherein, when the selection means selects a certain group, the communication means accesses websites indicated by URLs of all bookmarks belonging to the group and acquires data, and
the display means displays all the acquired data in accordance with a display position and a display size of a display window registered in the group registration means.
